(19) United States
(12) Patent Application Publication
(10) Pub. No.: US 2006/0163166 A1
(43) Pub. Date: Jul. 27, 2006

(54) Apparatus for moving particles from a first fluid to a second fluid

(76) Inventors: Jeremy John Hawkes, Manchester (GB); William Terence Coakley, Cardiff (GB)

Correspondence Address: JOHN S. PRATT, ESQ;KILPATRICK STOCKTON, LLP, 1100 PEACHTREE STREET, ATLANTA, GA, 30309, US

(21) Appl. No.: 10/530,131

(22) PCT Filed: Oct. 10, 2003
(86) PCT No.: PCT/GB03/04373

§ 371 Date: Jan. 24, 2006

(30) Foreign Application Priority Data
Oct. 10, 2002 (GB) 0223562.0

(51) Int. Cl. B03B 7/00; B01J 19/10

(52) U.S. Cl. 210/748; 209/18; 209/590

(57) ABSTRACT

There is disclosed apparatus for moving particles entrained in a first fluid to a second fluid, comprising a conduit, means providing for contacting laminar flow of each fluid within the conduit and means capable of generating a standing sound wave having a pressure node disposed within the conduit.

The present invention is generally concerned with apparatus and methods for moving particles between fluids. The invention is particularly, although not exclusively, directed to the micro-scale washing of microbiological samples or isolates such as, for example, cells, spores, and DNA.

The isolation and manipulation of a microbiological sample generally requires one or more washing steps often involving repeated centrifugation and re-suspension of the sample. The speed with which such samples can be handled is, however, inherently limited by the requirement for manual handling. Although robotisation is possible, it does not provide an elegant route to automation and has little potential for the development of rapid cell monitoring systems.

There is consequently a desire for an improved method of washing microbiological samples, which also permits micro-scale transfer between different fluids. The present invention generally seeks to achieve this end by adaptation of known methods of particle manipulation through ultrasound standing waves.

International Patent Application WO 00/41794, incorporated by reference herein, discloses apparatus for ultrasonic filtration of yeast cells from a liquid in laminar flow. The apparatus comprises a steel chamber including a first wall comprising, in part, a ceramic ultrasonic transducer and transmission layer and an opposite second ultrasound reflecting wall (J. J. Hawkes and W. T. Coakley, Sensors and Actuators B, 2001, 75, 231-242). The first and second walls define a branched channel or conduit for the introduction and exit of an aqueous sample of the yeast cells.

The thickness of the transmission layer and the reflecting layer and the width of the channel or conduit are selected in accordance with the frequency of the alternating potential applied to the transducer so as to generate a single half wavelength ultrasound standing wave in the sample. A pressure node is located at or adjacent the centre of the channel or conduit.

In this system, (hereinafter referred to as a “half wavelength system”) the thickness of the transmission layer is an odd integer multiple of a quarter of the wavelength of sound therein and the thickness of the reflecting layer is an odd integer multiple of a quarter wavelength of sound therein (J. J. Hawkes et al., J. Acoust. Soc. Am., 2002, 111(3), 1259-1256).

As sample flow is maintained through the system, acoustic forces drive the yeast toward the pressure node so that a concentrated sample emerges through a first exit and a substantially clarified sample emerges through a second (branched) exit.

The ultrasonic standing wave radiation force also separates dissimilar phases in a fluid to nodal or anti-nodal positions. In particular air bubbles in an aqueous medium are driven toward the pressure anti-node whilst bacteria are driven to the pressure node. It will also be apparent that the filter provides for a single band of particles and that the laminar flow enables an additional mechanism of fluid manipulation in the system having fewer variables than systems including turbulent flow.

These features are also found in a device for positioning particles within a gel (L. Gherardini et al., Proc. Int. Workshop on Bioencapsulation IX: “Bioencapsulation in Biomedical, Biotechnological and Industrial Applications”, Warsaw, Poland, 2001, P3) and similar features are described (P. Jenkins et al., J. Immuno. Methods, 1997, 205, 191-200) in a commercially available immunoagglutination device (Immunosonic, Electro Medical Supplies, Wantage, UK).

The methods provided by these apparatus may be thought of as field flow fractionation (FFF) techniques such as those based on electric fields (J. C. Giddings, Sep. Sci, 1996, 1, 123 and N. Tri et al., Anal. Chem, 2000, 72, 1823-1829) and/or acoustic fields as described in International Patent Application WO 02/29400.

The present invention builds upon the aforementioned features of these known apparatus so as to enable transfer of particles between fluids. As used herein “particle” is intended to mean, in particular, bacteria, cells and cell fragments, spores, plasmid and other DNA, viruses and large protein molecules. The present invention is most effective for particles having a diameter of at least one micron.

In a first aspect, the present invention provides apparatus for moving particles from a first fluid to a second fluid comprising a conduit, means providing for contacting laminar flow of each fluid within the conduit and means capable of generating a standing ultrasonic sound wave having a pressure node disposed within the conduit.

The means providing for contacting laminar flow within the conduit should preferably minimise mixing between the fluids. Although, laminar flow is, to a certain extent, dictated by the scale (mm) of the apparatus, such means comprise respective inlet and outlet means for each fluid, which inlet and outlets communicate with one or other side of the conduit. In a preferred embodiment, the respective inlet and outlet means are orthogonal to each other. Each inlet and outlet means is preferably associated with tubing and pump means so as to control the flow rate of each fluid in the conduit. In one embodiment the pump means are provided at a first inlet port and a first and second outlet port leaving a second inlet port able to release any back pressure.

Further, there is no requirement that the fluids are immiscible or even differ from each other. In a preferred embodiment each fluid comprises water.

It will be understood from the above discussion, that it is not necessary that the standing wave have a pressure node that is centrally located within the conduit. Nor does the invention necessarily require a single pressure node (½ wavelength system). A pressure node should, however, be located in the fluid to which it is intended the particles transfer and not in the fluid from which they transfer. Further, the standing wave and pressure node need not be present along the whole of the length of this axis. The laminar flow allows manipulation of the positioned particles downstream from this region.

A half wavelength system is, however, preferred. Still more preferably, the pressure node is located at or adjacent the central longitudinal axis of the conduit.

Thus, the means for generating the standing wave may comprise a first wall of the conduit adapted to generate and transmit a sound wave and a second opposite wall adapted to reflect the sound wave. Of course, the means capable of generating the standing wave also include an alternating potential source. The potential source may, for example, comprise an alternating signal generator (2.91 MHz, Hewett Packard 3326A) and an amplifier (Model 240L, ENI, Rochester, US).

In a first preferred embodiment of the present invention, the first wall comprises a piezoceramic of thickness giving resonance at 3 MHz (Ferroperm, Krisgard, Denmark) and a steel transmission layer of 2.5 mm thickness ( 5/4 wavelength), the second wall comprises a steel reflector of 1.5 mm thickness (¾ wavelength) and the width of the conduit or channel is 0.25 mm (½ wavelength).

A second preferred embodiment, differs in that the first wall comprises a steel transmission layer of thickness 3.1 mm ( 3/2 wavelength) and the second wall comprises a quartz reflector of thickness 1.5 mm (¾ wavelength).

The present invention also provides a method of moving particles from a first fluid to a second fluid comprising the steps of i) providing for contacting laminar flow of each fluid within a conduit associated with means capable of generating an ultrasound standing wave therein and ii) generating a standing wave having a pressure node within the conduit.

It will be understood that the method is performed in continuous mode. Although the optimum flow rate will be determined in relation to the effect of ultrasound, preferably, the flow rate of each fluid minimises turbulent mixing of the fluids and maximises transfer by molecular diffusion.

The method of the present invention is performed using the apparatus described above. Preferably, the method uses a half wavelength system in which a single node is present in the fluid to which it is intended that the particles transfer.

In one embodiment, therefore, in which the fluids respectively comprise an aqueous suspension of yeast cells containing sodium fluorescein or dye and water, the relative flow rate at the first inlet/outlet is about 90% of the flow rate at the second inlet/outlet. The determination of relative flow rates will, however, vary according to the nature of the fluids and particles.

In one embodiment, in which preferred apparatus is used, the overall flow rate varies over the range from about 4.0 to 11 ml min⁻¹ (relative rate about 90% as above). For example, the optimum overall flow rate for separation of yeast cells in water (1×10⁸ ml⁻¹) containing a red dye (1% v/v) using the first preferred apparatus is found to be 4.65 ml min⁻¹. The interface between the first and second fluid (both water) is calculated to be about 53 μm from the first wall in the inlet region. The Reynold's number is calculated as about 8.6.

The optimum flow rate for separation of yeast cells in water (1×10⁸ ml⁻¹) containing sodium fluorescein (1% w/v) using the second preferred apparatus is found to be 10.2 ml min¹. The interface between the first and second fluid (both water) is calculated to be about 64 μm in the inlet region and about 81 μm in the outlet region. The Reynold's number is calculated as about 37.

The magnitude of the potential applied to the transducer can be determinative for separation of, for example, particles in water from molecular species. In a first, preferred embodiment (washing), therefore, the magnitude of the voltage is selected so as to facilitate transfer of the particles only.

For the second preferred apparatus, the optimum voltage providing for the washing of the yeast cells from sodium fluorescein was found to be in the region just below 17 Vₚ₋ₚ. Yeast clumping and sticking as well as increased sodium fluorescein transfer was found at voltages above this figure.

In a second embodiment (mixing), the magnitude of the voltage is selected so as to facilitate transfer of both particles and molecular species. Thus, where the fluids are the same, the samples emerging from each outlet may be substantially similar. This embodiment is particularly useful where it is desired that samples are divided or transferred between solvents.

For the second preferred apparatus, voltages providing for optimum mixing of the yeast cells and sodium fluorescein from water to water are best in the region of 20 to 40 Vₚ₋ₚ.

The present invention provides apparatus having no moving mechanical parts or consumable items. The apparatus is applicable to complex automation tasks and use in inaccessible locations. The apparatus avoids the build up of back pressure and is not blocked. The forces acing on the particles are gentle by comparison to centrifugation forces and exposure times may be less than one second. The apparatus and method, therefore, provides an alternative to centrifugation in which handling losses are minimised. The apparatus is particularly suitable for complex operations at microscale.

The present invention will now be described, by way of example, with reference to the following drawings and Examples in which

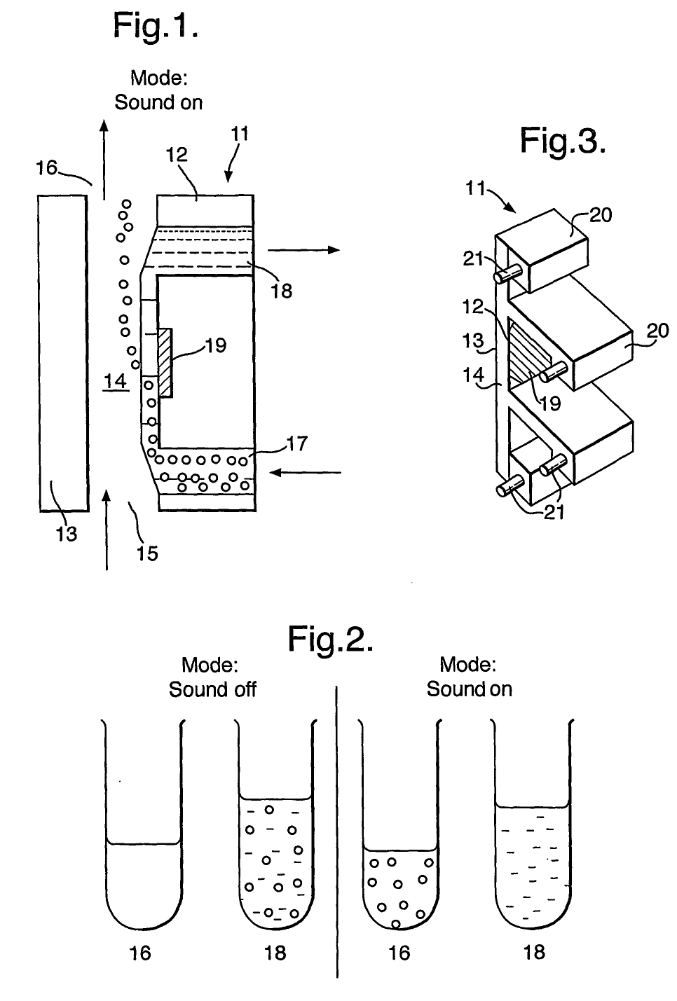

FIG. 1 is a schematic view of one embodiment of the apparatus and method of the present invention;

FIG. 2 is a schematic view highlighting the separation according to the present invention of yeast particles from an aqueous dye solution;

FIG. 3 is a perspective view of a preferred embodiment of the apparatus of the present invention; and

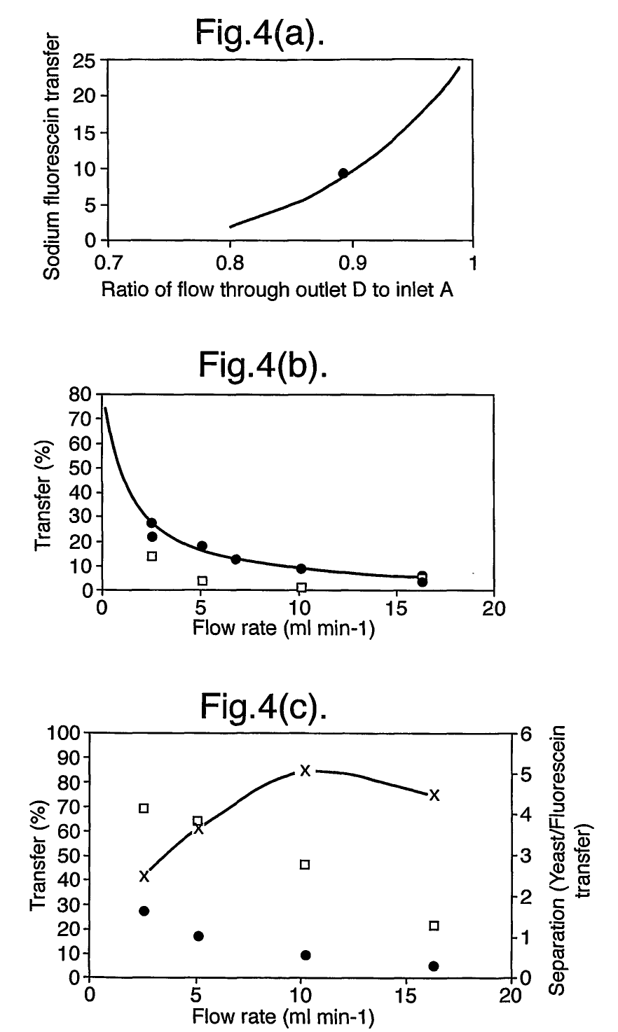

FIGS. 4 a) to c) are graphs illustrating the transfer of yeast cells and sodium fluorescein according to the present invention from water to water.

Referring now to FIG. 1, apparatus according to the present invention, comprises a steel chamber, generally designated 11, having a first wall 12 and a second opposite wall 13 which define a conduit or channel 14 for the passage of the fluids there through. The channel 14 is in direct communication with a first inlet 15 and first outlet 16. Slots or apertures 17 and 18 defined by the first wall provide a second inlet and second outlet to the channel. The second inlet 17 and outlet 18 are orthogonal to the first inlet 15 and first outlet 16 and the longitudinal direction of the channel 14.

The first wall 12 of the chamber also defines a recess in an outer surface in which a piezoceramic transducer 19 is provided in contact therewith. The transducer is, therefore, in contact, with the first wall along only a part of its longitudinal length. An alternating potential source (not shown) including a signal generator and an amplifier operate the transducer 19.

Although the chamber is used in the vertical sense (shown) one or more inlets and outlets are associated with tubing and pump means (not shown) for introducing and controlling the fluid to the channel 14. The overall and relative flow rates are adjusted so as to provide for laminar flow and a fluid-fluid boundary close to the first wall (for example).

In use, water is supplied to the first inlet 15 and passes in contact with the second wall 13 through the channel 14 to the first outlet 16. At the same time an aqueous suspension of particles (O) containing a dye (−) is supplied (for example) to the second inlet 17. The suspension passes from the second inlet in contact with the first wall 12 through the channel 14 to the second outlet 18.

Actuation of the potential source generates an ultrasound standing wave radiation (not shown) across the channel 14 along a central longitudinal axis. The longitudinal extent of the standing wave in the channel is confined approximately to that area of the channel 14 adjacent to the transducer 19.

The acoustic forces acting on the particles (o) at the selected frequency and magnitude of the potential are greater than those acting on the dye (−) . The particles (O) are therefore preferentially driven across the water-water boundary toward the pressure node in the centre of the channel 14 and exit downstream of the standing wave through the first outlet 16. The dye (−) , however, does not escape the boundary of the suspension and exits downstream of the standing wave through the second outlet 18.

The output from the first outlet 16 and the second outlet 18 is schematically compared in FIG. 2 before (left-hand side, OFF mode) and after (right-hand side, ON mode) exposure to the ultrasound standing wave. As may be expected, in the OFF mode, the output of the first outlet 16 is clear and the output of the second outlet 18 is coloured/turbid (−/o). However, following exposure to the standing wave (ON mode), the output of the first outlet 16 is clear/turbid (o) and the output of the second outlet 18 is coloured (−) .

Referring now to FIG. 3, apparatus according to preferred embodiments of the present invention comprises a chamber 11 substantially similar to that shown in FIG. 1. The first wall 12 of the chamber comprises a plurality of limb portions 20 that are each orthogonal to the wall. Limb portions 20 each define a slot (not shown) extending across the width of the first wall and tapering outwards toward an aperture providing a fluid delivery or collection tubing 21. The upper limbs thus provide first and second outlet means to the chamber and the lower limbs first and second inlet means.

In a first preferred apparatus, the first wall comprises stainless steel of width 10 mm and thickness 2.5 mm ( 5/4 wavelength) except at limb portion. The second wall comprises a stainless steel (Stavax) ultrasound reflector of width 10 mm and thickness 1.5 mm (¾ wavelength). The slots (0.25×10 mm) in the inner limb portions are arranged 60 mm apart. The first and second walls are clamped together so as to define the channel 14 which is maintained at 0.25 mm (½ wavelength-water) by a silicone rubber gasket and brass shim arrangement provided at the periphery of the walls.

A PZ26 piezoceramic transducer (3 MHz, Ferroperm, Krisgard, Denmark), in which the silver electrode (30×30×0.67 mm) has been etched to reduce its surface area to 10×20 mm, is attached between the inner limbs to the outer surface of the first wall by an epoxy resin.

A second preferred apparatus differs from the above in that the second wall comprises quartz (Spectrocil B, Chandos Intercontinental, Chapel en le Frith, UK) of thickness 1.5 mm (¾ wavelength) and the first wall (stainless steel, Stavax) of thickness 3.1 mm ( 3/2 wavelength). The distance between the slots provided in the inner limb portions is 51 mm. The slots provided in the outer limb portions have dimension 2×10 mm. The gasket comprises polydimethylsiloxane (PDMS, Sylgard™ 184, Dow Corning, UK).

### EXAMPLE 1

First Preferred Apparatus

First Fluid/First inlet: degassed water

Second Fluid/Second inlet: suspension of yeast cells (reconstituted dried, Boots, Nottingham, UK 1×10⁸ ml⁻¹) in degassed water containing 1% (v/v) red food colouring (Carmoisine, Sunset Yellow, Supercook, Leeds, UK).

The total volume flow rate was controlled at 4.65 ml min⁻¹ by three pumps (Gilson Mini-puls 3) and a tubing arrangement previously described by J. J. Hawkes and W. T. Coakley, in Sensors and Actuators B, 2001, 75, 231-242. A first pump was placed at the first outlet 16 (3.66 ml min⁻¹), a second at the second outlet 18 (0.99 ml min⁻) and the third at the second inlet 17 (0.56 ml min⁻¹). The flow of water from a reservoir (not shown) to the first inlet 15 (4.09 ml min⁻¹) was not pump controlled.

The Reynold's number in the channel 14 is calculated as 8.6 in this system and, assuming a parabolic flow path the interface between the 12% of total flow input to the second inlet 17 and the 88% to the first inlet is calculated as 53 μm from the first wall. The residence time of the fluids in the channel is calculated as 1.9 s.

Sound Mode OFF

A visually clear output from the first outlet 16 was obtained by reducing the flow rate thereat to 10.5% below the flow rate at the first inlet. The result suggests diffusion of molecular species is significant.

Sound Mode ON

An alternating potential of 2.5 V at frequency 2.91 MHz was applied to the transducer 19. The phase rather than voltage minimum most accurately reflects acoustic resonance in this system (J. J. Hawkes et al., J. Applied Microbiology, 1997, 82, 39-47). The current/voltage phase minimum was monitored by a phase comparator block including a Phase-locked Loop IC (Philips PC74HC4046AP).

Yeast cells were clearly visible in the output from the first outlet 16 without visible carry over of the dye. The output from the second outlet 18 became depleted of the yeast cells.

It will be apparent, therefore, that at this voltage, the apparatus provides for continuous washing of yeast cells from the dye. Higher voltages, however, did lead to some carry over of the dye. This carry over may be due to other streaming forces, such as Rayleigh streaming, which can arise from ultrasound as well as temperature effects and/or entrainment of the dye with the movement of the yeast cells.

### EXAMPLE 2

Second Preferred Apparatus

First fluid/First inlet: degassed water

Second fluid/second inlet: suspension of yeast cells (1×10⁶ to 2×10⁸ ml min⁻¹) in degassed water containing sodium fluorescein (1 mM, Sigma, UK).

Yeast concentrations in all outlet samples were calculated from heamocytometer counts. Centrifugation of the samples and analysis of the supernatant allowed sodium fluorescein to be determined by its absorbance at 485 nm (Shiimadzu UV-2401PC spectrophotometer).

The total volume flow rate was controlled at 10.2 ml min⁻¹ by three pumps (Gilson Mini-puls 3) and the tubing arrangement referred to above. A first pump was placed at the first outlet 16 (2.6 ml min⁻¹), a second at the second outlet 18 (7.6 ml min⁻¹) and the third at the second inlet 17 (1.7 ml min⁻¹). The flow of water from the to the first inlet 15 (8.5 ml min⁻¹) was not pump controlled.

The Reynold's number in the channel 14 is calculated as 37 in this system and, assuming a parabolic flow path the interface between the 17% of total flow input to the second inlet 17 and the 83% to the first inlet is calculated as 64 μm from the first wall. The corresponding figure in the region of the outlet is calculated as 81 μm. The residence time of the fluids in the channel is calculated as 0.3 to 0.45 s.

Sound Mode OFF

A visually clear output from the first outlet 16 was obtained by reducing the flow rate thereat to about 90% of the flow rate at the first inlet although spectrophotometer measurements indicated that about 9.1% is still transferred. Referring now to FIG. 4 a), the measured transfer of sodium fluorescein (•) is in good agreement with CFD calculations and confirms that the dominant mechanism of transfer is diffusion controlled.

Referring now to FIG. 4 b) the transfer of sodium fluorescein (•) decreases with increasing overall flow rate (about 6% at 16.3 ml min⁻¹). The transfer of yeast (□) is much lower than sodium fluorescein at all the flow rates used.

Sound Mode ON

An alternating potential of 17 Vₚ₋ₚ at frequency 2.96 MHz was applied to the transducer 19 using a signal generator (Hewitt Packard 3325A) and amplifier (Model 240L, Rochester, US). The frequency for resonance was determined by monitoring the phase angle between the current and the voltage for a minimum using an oscilliscope (Agilent, 5462A).

Referring now to FIG. 4 c) a dramatic increase (5 to 40 fold depending on flow rate) in number of yeast cells in the output from the first outlet 16 was observed. An increase in the transfer of sodium fluorescein was also observed but this is less than 1% at this voltage. Separation of yeast from sodium fluorescein (x-x line, right hand ordinate) is optimal at a flow rate of 10 ml min⁻¹ at 17 Vₚ₋ₚ for an initial yeast concentration of 1.53×10⁷ ml⁻¹.

Increased yeast transfer was obtained at higher voltages up to about 30 Vₚ₋ₚ although the transfer of sodium fluoroscein was also increased. At voltages of this magnitude the output from the first outlet 16 is very similar to that from the second outlet 18.

A similar experiment investigating the transfer of sodium fluorescein in the absence of yeast cells shows that up to 40% transfer occurs at high voltages. Temperature effects, however, have little effect. The entrainment of sodium fluorescein with the transfer of yeast is thought to account for only about 10% of the transfer at 17 Vₚ₋ₚ (CFD calculations).

These results taken together suggest that acoustic streaming is mainly responsible for sodium fluorescein transfer. Optimum mixing of inlet samples requires high yeast concentrations, which influence sodium fluorescein transfer through sticking or clumping as well as high voltages.

It is expected that improved separation efficiencies can be obtained according to the method of the present invention where the molecular species has a lower diffusion co-efficient than sodium fluorescein.

1. Apparatus for moving particles entrained in a first fluid to a second fluid, comprising a conduit, mans providing for contacting laminar flow of each fluid within the conduit and means capable of generating a standing sound wave having a pressure node disposed within the conduit.

2. Appratus according to claim 1, in which the means providing for contacting laminar flow minimise mixing between the two fluids.

3. Apparatus according to claim 1, in which the means for arranging contacting laminar flow comprise respective inlet and outlet means for each fluid in communication with the conduit.

4. Apparatus according to claim 3, in which the respective inlet and outlet means are orthogonal to each other.

5. Apparatus according to claim 1, in which the pressure node is centrally disposed along the longitudinal length of the conduit.

6. Apparatus according to claim 1, in which the means capable of generating the standing sound wave comprise a first wall of the conduit adapted to generate and transmit a sound wave and a second, opposite wall adapted to reflect the generated sound wave.

7. Apparatus according to claim 6, in which the first wall of the conduit comprises a piezoceramic material.

8. Apparatus according to claim 7, in which the piezoceramic material is associated with an alternating potential source.

9. A method of moving particles from in a first fluid to a second fluid, comprising the steps of i) providing for contacting laminar flow of each fluid within a conduit having means capable of generating a standing sound wave and ii) generating a standing sound wave having a pressure node within the conduit.

10. A method of washing particles according to claim 9.

11. A method of mixing samples according to claim 9.

12. (canceled)

13. (canceled)
